(19) United States
(12) Patent Application Publication
(10) Pub. No.: US 2008/0006531 A1
(43) Pub. Date: Jan. 10, 2008

(54) Ceramic H2S sensor

(76) Inventor: Christopher T. Holt, Columbus, OH (US)

Correspondence Address: Porter, Wright, Morris & Arthur LLP;IP DOCKETING, Attn: Belinda Reynolds, 41 South High St., 29th Floor, Columbus, OH, 43215-6194, US

(21) Appl. No.: 11/637,624

(22) Filed: Dec. 12, 2006

Related U.S. Application Data
(60) Provisional application No. 60/749,378, filed on Dec. 12, 2005.

(51) Int. Cl. G01N 27/333

(52) U.S. Cl. 204/419; 205/786.5; 29/592.1

(57) ABSTRACT

A sensor capable of monitoring hydrogen sulfide in a hydrogen-containing background. The sensor comprises novel sulfur sensitive materials that may be deposited as a thin film or thick film in a chemi-resistor format. The novel sulfur sensitive materials may comprise a single component oxide material or a composite of two or more oxide materials. The sensors respond reversibly to H₂S in a reducing gas environment, with a corresponding change in their electrical resistance that can be used to quantify the amount of H₂S present in the reducing gas.

### STATEMENT REGARDING FEDERALLY SPONSORED RESEARCH

This invention was made with government support under Contract No. DE-FC26-02NT41576 awarded by the United States Department of Energy. The United States Government has certain rights in this invention.

### CROSS-REFERENCE TO RELATED APPLICATIONS

Not applicable

### REFERENCE TO MICROFICHE APPENDIX

Not applicable

### FIELD OF THE INVENTION

This invention relates to ceramic-based H₂S sensors, and particularly all-ceramic H₂S sensors operating in a planar chemi-resistor mode that detect H₂S in a reducing gas stream. The invention may be useful in fuel processing components of fuel cell systems operating on hydrocarbon fuels (e.g., natural gas, propane, LPG, diesel, and coal), in hydrodesulfurization systems such as those in petroleum refineries, and other applications in which detection and quantification of H₂S in a reducing atmosphere is desired.

### BACKGROUND OF THE INVENTION

Fuel cells are quiet, environmentally clean and highly efficient devices for generating electricity and heat from hydrocarbon fuels (natural gas, propane, LPG, gasoline, diesel, etc.) that exist within our existing infrastructure. The use of these hydrocarbon fuels in fuel cells typically requires that the fuel be processed (via reforming) into a gaseous mixture of hydrogen and carbon monoxide before being delivered to a solid oxide (or molten carbonate) fuel cell or further purified into hydrogen before being delivered to a proton exchange membrane (PEM) fuel cell. The reforming step is performed by the reaction of the hydrocarbon fuel with steam and/or air over a catalyst. The situation is complicated because hydrocarbon fuels inevitably contain sulfur. The sulfur compounds (mercaptans and thiophenes) are poisons to the reforming catalysts. If present, these sulfur compounds are converted to H₂S during reforming and this H₂S is a poison to nickel based SOFC anodes. Long-term exposure of sulfur to the reforming catalysts and fuel cell anodes leads to irreversible degradation. Thus, system designers typically include a fuel desulfurization component (a bed of a sulfur-adsorptive material) so the sulfur may be removed from the fuel before it enters the reformer. These sulfur absorption beds periodically must be replaced (or in some cases regenerated). The primary purpose of an H₂S sensor is to provide feedback to protect the reformer and the fuel cell stack. Without such a sensor, sulfur absorption beds will need to be replaced on a very conservative schedule which greatly increases maintenance costs.

Hydrogen sulfide sensors are commercially available, but these sensors have been designed for operation in ambient air (i.e., for safety purposes) and do not operate at elevated temperatures and in reducing environments common to the fuel cell application. They are predominantly based on the familiar tin oxide (Figaro and Taguchi) technology with one or more minor additives (such as Au, Pd, CuO, NiO, etc.). These prior art devices work on the principle of change in film resistance upon exposure to H₂S in air over a limited range of temperatures and concentrations. For example, tin oxide is considered to be an n-type semiconductor and the sensing behavior of n-type semiconductors appears to be governed by the adsorption of oxygen in the neck regions between the grains. Adsorption of oxygen from the ambient increases the resistance of the film due to extraction of electrons from the conduction band. This leads to the depletion of electrons and creation of a space charge region near the surface. Eventually a steady-state condition is achieved and the charge transfer to adsorbed oxygen is impeded due to the electrostatic field at the surface. In the presence of a reducing gas (which reacts with the adsorbed charged oxygen species on the surface), electrons are donated to the conduction band and the conductivity is seen to increase. Non-specificity is a major drawback of devices of this type. The alarm sounds even when a volatile species such as alcohol is present in its vicinity.

Optical devices based on flame photometry or chemiluminescence are tedious, intrusive, and expensive in addition to being capable of detecting sulfur in solution only. Other detectors for H₂S include surface acoustic wave (SAW) devices (Au doped-WO₃), MOS devices (Pd|SiO₂|Si), current-voltage or I-V devices (SnO₂|CuO|SnO₂), and electrochemical sensors (where the EMF changes when H₂S is adsorbed on PbS surface or when it encounters a sulfuric acid-soaked Nafion film). Again, the temperature and concentration range of these techniques are low and they operate in ambient air.

As stated above, a need exists to remove sulfur from the fuel before it reaches the anode of a fuel cell. Equally important in this process is the detection and continuous monitoring of sulfur in the reformed fuel at various locations in the fuel cell system. This calls for the development of reliable and rugged sensors that are mechanically robust and capable of withstanding the harsh and reducing environment over a wide range of temperatures. We are unaware of any sensor capable of monitoring hydrogen sulfide in H₂-containing background.

### SUMMARY OF THE INVENTION

The present invention provides a sensor capable of monitoring hydrogen sulfide in a hydrogen-containing background. The sensor comprises novel sulfur sensitive materials deposited as a thin film or thick film in a chemi-resistor format (see FIG. 1). The sensor film responds reversibly to the presence of H₂S in a reducing gas via a change in the film resistance, which can be used to quantify the amount of H₂S present in the reducing gas. The device geometry shown in FIG. 1 is an example of one type of sensor geometry that may be used in conjunction with the novel sulfur sensitive materials of the present invention. Other device geometries also may be used, provided they allow a resistance change of a thin film or thick-film coating of the sulfur sensitive materials of the present invention.

The thick-film composition comprises a single metal oxide or a composite of at least two oxides. When a single metal oxide is used as the sensor, the selection of the metal oxide is based on its ability to reversibly form a sulfide in the presence of H₂S in a reducing gas stream. For composite formulations, the oxides are selected such that one tolerates the reducing environment and exists as a stable phase and the other reversibly forms a sulfide in the presence of H₂S in the reducing gas stream.

The invention provides a sulfide-sensitive composition that responds reversibly to hydrogen sulfide in a reducing environment. The composition is selected from a binary metal oxide, a ternary metal oxide containing molybdenum, a ternary metal oxide containing tungsten, a quaternary metal oxide containing molybdenum, a quaternary metal oxide containing tungsten, and combinations thereof. The binary metal oxide may be selected from ZnO, MoO₃, WO₃, NiO, CoO, and combinations thereof. A hydrogen sulfide sensor may include the sulfide-sensitive composition applied to an electrode, for example, as an ink.

The invention also provides a sulfide-sensitive composite material that responds reversibly to hydrogen sulfide in a reducing environment. The composite material comprises a metal oxide selected from a binary metal oxide, a ternary metal oxide containing molybdenum, a ternary metal oxide containing tungsten, a quaternary metal oxide containing molybdenum, a quaternary metal oxide containing tungsten, and combinations thereof; and a ceria-based oxide composition.

The invention further provides hydrogen sulfide sensors. In one embodiment, the sensor comprises a substrate and a sulfide-sensitive composite deposited on the substrate such that the sulfide-sensitive material is connected to a pair of electrodes. The sulfide-sensitive material responds reversibly to hydrogen sulfide in a reducing environment. This material may comprise a metal oxide selected from a binary metal oxide, a ternary metal oxide containing molybdenum, a ternary metal oxide containing tungsten, a quaternary metal oxide containing molybdenum, a quaternary metal oxide containing tungsten, and combinations thereof. The composite also may comprise at least one ceria-based oxide composition, which may include undoped cerium oxide, doped cerium oxide, or a combination thereof. The composite may further comprise alumina in an amount from 1 to 50 wt %, a promoter selected from ruthenium, rhodium, palladium, platinum, gold, silver, and combinations thereof in an amount from 0.1 to 10 wt %, or both alumina and a promoter.

In another embodiment, the hydrogen sulfide sensor comprises a substrate, an inter-digitated electrode deposited on the substrate, and a sulfide-sensitive composite material deposited on the inter-digitated electrode as a thick film in a chemi-resistor format. The sulfide-sensitive composite material responds reversibly to hydrogen sulfide in a reducing environment and comprises 5 wt % MoO₃, 10 wt % alumina, and GDC or 5 wt % NiWO₄, 10 wto/o alumina, and GDC. The composite may further comprise a promoter selected from ruthenium, rhodium, palladium, platinum, gold, silver, and combinations thereof in an amount from 0.1 to 10 wt %.

The hydrogen sulfide sensors of the present invention may be pretreated by exposure to a hydrogen gas stream that contains hydrogen sulfide gas at a temperature from 450-600° C. Preferably, the pretreatment temperature is 600° C.

The present invention also provides a method of making a hydrogen sulfide sensor. The method comprising the steps of selecting a sulfide-sensitive composite material including a ceria-based oxide composition and a metal oxide selected from a binary metal oxide, a ternary metal oxide containing molybdenum, a ternary metal oxide containing tungsten, a quaternary metal oxide containing molybdenum, a quaternary metal oxide containing tungsten, and combinations thereof; depositing the sulfide-sensitive composite material on a substrate as a thick film in a chemi-resistor format; and connecting a pair of electrode to the sulfide-sensitive composite material. The sulfide-sensitive composite may further comprise alumina in an amount from 1 to 50 wt % or a promoter selected from ruthenium, rhodium, palladium, platinum, gold, silver, and combinations thereof in an amount from 0.1 to 10 wt %. The method further may include the step of pretreating the sensor by exposure to a hydrogen gas stream that contains hydrogen sulfide gas at a temperature from 450-600° C.

### BRIEF DESCRIPTION OF THE DRAWINGS

These and further objects of the invention will become apparent from the following detailed description.

FIG. 1 is a schematic diagram of the inter-digitally electroded (IDE) substrate used for planar sensor fabrication and testing.

FIG. 2 is a graph of the resistive response of a 5 wt % MoO₃-95 wt % GDC sensor during cycling between 0 and 10 ppm H₂S in a 90% N₂, 10% H₂ gas mixture at 350° C.

FIG. 3 is a graph of the resistive response of a 5 wt % MoO₃-95 wt % GDC sensor during cycling between 0 and 10 ppm H₂S in a 90% N₂, 10% H₂ gas mixture at 295° C.

FIG. 4 is a graph of the resistive response of a 5 wt % MoO₃-95 wt % GDC sensor during cycling between 0 and 10 ppm H₂S in a 90% N₂, 10% H₂ gas mixture at 420° C.

FIG. 5 is a graph of the resistive response of a 5 Wt % MoO₃-95 wt % GDC sensor during cycling between 0 and 10 ppm H₂S in a 90% N₂, 10% H₂ gas mixture at 350° C.

FIG. 6 is a graph of the resistive response of a 5 wt % MoO₃-95 wt % GDC sensor during cycling between 0 and 10 ppm H₂S in a 90% N₂, 10% H₂ gas mixture at 500° C.

FIG. 7 is a graph of the resistive response of a 5 wt % MoO₃-95 wt % GDC sensor during cycling between 0 and 10 ppm H₂S in a 90% N₂, 10% H₂ gas mixture at 400° C.

FIG. 8 is a graph of the resistive response of a 5 wt % MoO₃-95 wt % GDC sensor during cycling between 0 and 10 ppm H₂S in a 90% N₂, 10% H₂ gas mixture at 350° C.

FIG. 9 is a graph of the resistive response of a 5 wt % WO₃ 95 wt % GDC sensor during cycling between 0 and 10 ppm H₂S in a 90% N₂, 10% H₂ at 400° C.

FIG. 10 is a graph of the quantitative resistive response of a 5 wt % MoO₃-10% wt % Al₂O₃-85 wt % GDC sensor to 2.5 and 5 ppm H₂S at 500° C. in a humidified gas mixture consisting of 60% N₂, 27% H₂, 10% CO₂, and 3% H₂O.

FIG. 11 is a graph of the resistive response of a 5 Wt % MoO₃-10% wt % Al₂O₃-85 wt % GDC sensor to 1 ppm H₂S at 350° C. in a humidified gas mixture consisting of 60% N₂, 27% H₂, 10% CO₂, and 3% H₂O.

FIG. 12 is a graph of the resistive response of a 5 Wt % MoO₃-10% wt % Al₂O₃-85 wt % GDC sensor to 0.5 ppm H₂S in 500° C. in a humidified gas mixture consisting of 60% N₂, 27% H₂, 10% CO₂, and 3% H₂O.

FIG. 13 is a graph showing the effect of a pre-treatment (600° C. for 30 minutes in hydrogen with 5 ppm H₂S) on the sensitivity of 5 wt % MoO₃-10% wt % Al₂O₃-85 wt %₌ GDC sensors to 5% H₂S at 450° C. in a humidified gas mixture of 33% H₂ and 67% N₂.

FIG. 14 is a graph of the quantitative resistive response of a 5 wt % MoO₃-10% wt % Al₂O₃-85 wt % GDC sensor to 500, 100 and 50 ppb H₂S at 450° C. in a humidified gas mixture of 33% H₂ and 67% N₂.

FIG. 15 is a graph of the quantitative resistive response of a 5 wt % MoO₃-10% wt % Al₂O₃-85 wt % GDC sensor to 250, 100 and 50 ppb H₂S at 450° C. in a humidified gas mixture of 33% H₂ and 67% N₂.

FIG. 16 is a graph of the quantitative resistive response of a 5 wt % MoO₃-10% wt % Al₂O₃-85 wt % GDC sensor to 50 and 25 ppb H₂S at 450° C. in a humidified gas mixture of 33% H₂ and 67% N₂.

FIG. 17 is a graph of the resistance change (normalized to the baseline resistance) versus H₂S for a 5 wt % MoO₃-10% wt % Al₂O₃-85 wt % GDC sensor at 450° C. in a humidified gas mixture of 33% H₂ and 67% N₂.

FIG. 18 is a graph of the resistive response of a 5 wt % MoO₃-10% wt % Al₂O₃-85 wt % GDC sensor to 250 ppb H₂S in a dry gas mixture consisting of 98% CH₄ and 2% H₂.

FIG. 19 is a graph of the quantitative resistive responses of a NiWO₄ sensor to 250 and 500 ppb H₂S at 420° C. in a humidified gas mixture consisting of 33% H₂ and 67% H₂.

FIG. 20 is a graph of showing the response time of a NiWO₄ sensor to 250 ppb H₂S at 385° C. in a humidified baseline gas comprised of 33% H₂ and 67% N₂.

FIG. 21 is a graph of showing the resistive response of a NiWO₄ sensor to 500 ppb H₂S at 420° C. in a humidified baseline gas comprised of 50% CH₄, 33.6% H₂, and 16.4% N₂.

### DETAILED DESCRIPTION OF CERTAIN PREFERRED EMBODIMENTS

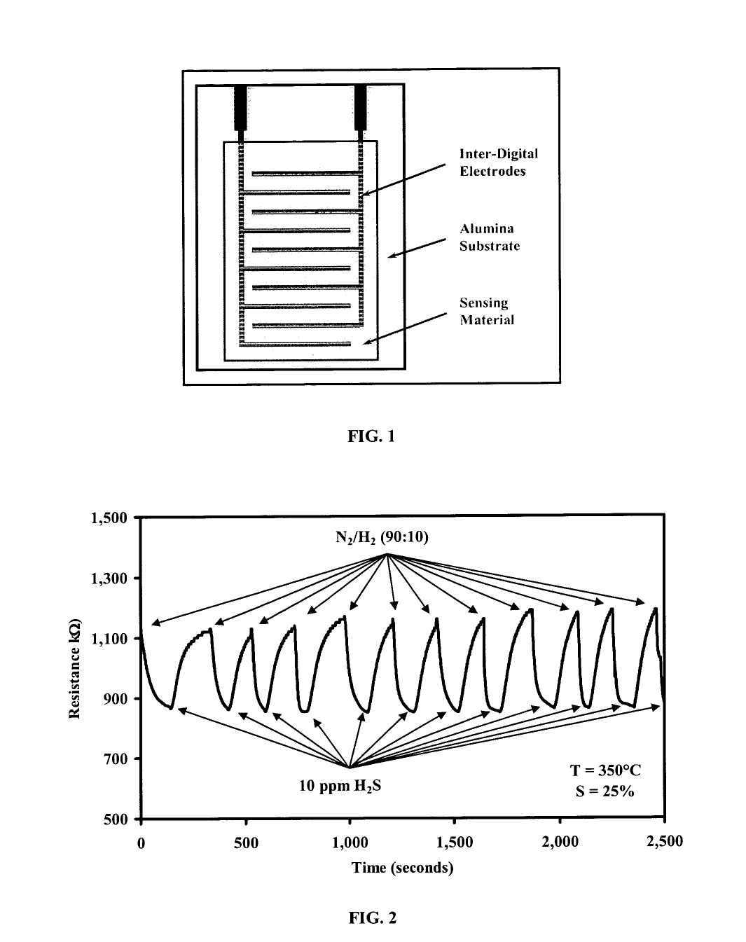

The present invention comprises novel sulfur sensitive materials deposited as a thin film or thick film in a chemi-resistor format (see FIG. 1). The sensor film responds reversibly to the presence of H₂S in a reducing gas (i.e., hydrogen, hydrogen-rich, and/or methane-rich gases) via a change in the film resistance, which can be used to quantify the amount of H₂S present in the reducing gas. Such sensors have applications in the fuel processing components of solid oxide fuel cell systems, molten carbonate fuel cell systems, phosphoric acid fuel cell systems, and PEM fuel cell systems. Other applications for H₂S detection and quantification in reducing gases exist within petroleum exploration, coal mining, petroleum refining, and hydrogen production.

The compositions of one embodiment of the present invention comprise a single component oxide material that reversibly forms a sulfide in the presence of H₂S in a reducing gas stream. A second embodiment of the invention comprises a composite of two or more oxide materials. The oxides of the composite are selected such that at least one oxide tolerates the reducing environment and exists as a stable phase in reducing gases and at least one other oxide reversibly forms a sulfide in the presence of H₂S in the reducing gas stream. The sensors of both embodiments respond reversibly to H₂S in a reducing gas environment, with a corresponding change in their electrical resistance that can be used to quantify the amount of H₂S present in the reducing gas.

A simple metal oxide or combination of metal oxides may form the active phase of a sensor for detecting H₂S in a reducing gas. Active sulfur sensitive phases within the present invention were identified based on a rigorous thermodynamic analysis of the energetics involved in the macroscopic and reversible formation of metal sulfides from their corresponding oxides in a H₂/H₂S mixture. Examples of sulfur sensitive phases identified from this analysis include binary metal oxides such as ZnO, MoO₃, WO₃, NiO, and CoO, ternary metal oxides such as ZnWO₄, MgWO₄, CoWO₄, NiWO₄, ZnMoO₄, MgMOO₄, CoMoO₄, NiMoO₄, and other ternary or quaternary metal oxides that contain molybdenum and/or tungsten. These active sulfur sensitive phases may be used to prepare H₂S sensors by themselves (as single-component sensor coatings) or in conjunction with other phases (such as ceria and/or alumina) in composite sensor formulations, as discussed below. In order to demonstrate H₂S sensors of the present invention, NiWO₄ was used as a single-phase sensor, and MoO₃ and WO₃ were used as components in composite sensors.

One of the preferred second phase materials for composite sensors is a ceria-based oxide. It is well known that ceria has excellent oxygen storage capacity (OSC); it is able to form oxygen vacancies in oxygen-poor atmospheres and conversely, to fill these vacancies in oxygen-rich atmospheres. The stoichiometric, oxidized form (CeO₂) and the non-stoichiometric, reduced form (CeO₂₋ₓ) are stable over a wide range of temperature and oxygen partial pressures. The present invention exploits this property of ceria to facilitate reversibility of the H₂S sensor when a H₂S-sensitive material is present as a first phase. A number of ceria compositions can be used for H₂S sensing with composite sensor formulations, including but not limited to undoped ceria (CeO₂) and doped ceria, such as Zr-doped ceria (ZDC), La-doped ceria (LDC), Sm-doped ceria (SDC), and Gd-doped ceria (GDC). When used as the second phase of a composite material, the ceria based oxides may be added to the active metal oxide phase in amounts ranging from 1 to 99 weight percent. The optimum amount of the ceria-based phase in composite H₂S sensors depends on the specific H₂S sensing application (i.e., baseline gas composition, temperature of the baseline gas, and the desired range of H₂S contents that need to be detected and quantified). In order to demonstrate composite H₂S sensors of the present invention, GDC was used as the second phase in composite sensor formulations.

Other second phase additions to either single component or composite sensor formulations also may provide benefits to H₂S sensors of the present invention. For example, alumina (Al₂O₃) may be added as an inert and insulating phase to increase baseline resistance of the sensor for applications in which H₂S sensitivity is desired at higher temperatures. The optimum amount of the Al₂O₃ addition may range from 1 to 50 wt % depending on the H₂S sensing application. Noble metal dopants also may be considered to facilitate catalysis (or promotion) of the sulfur adsorption and desorption reactions that are required for optimum sulfur sensitivity, response time, and recovery time. Examples of noble metal promoters include ruthenium, rhodium, palladium, platinum, gold and silver, and their optimum amounts would range from 0.1 to 10 wt %, also depending on the specific application. A combination of second phase additions may be used if desired.

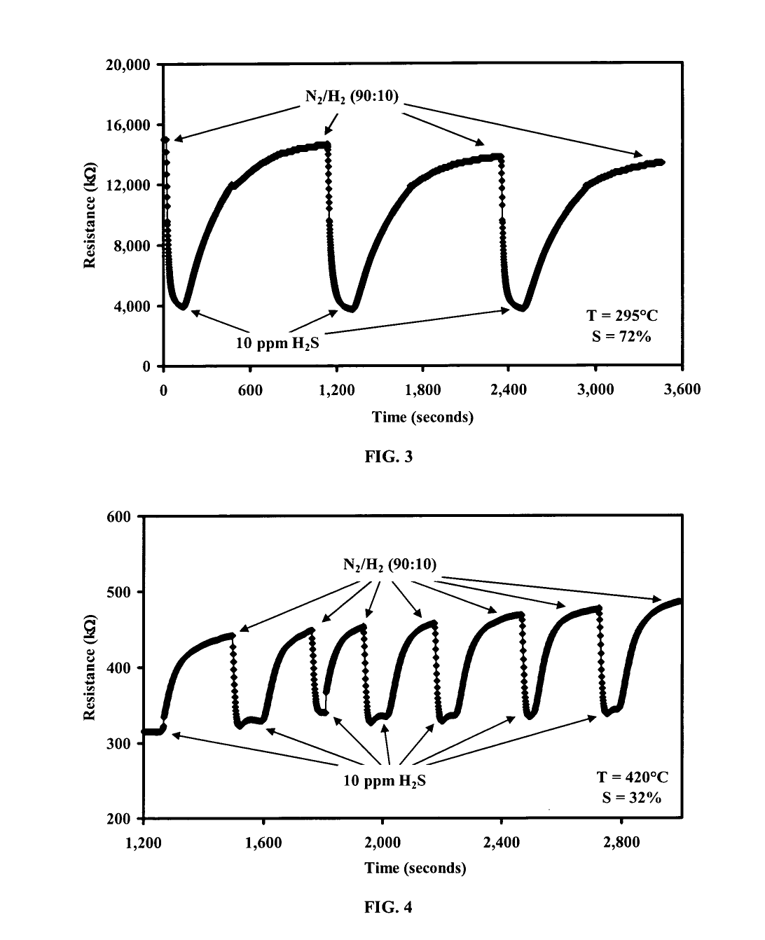

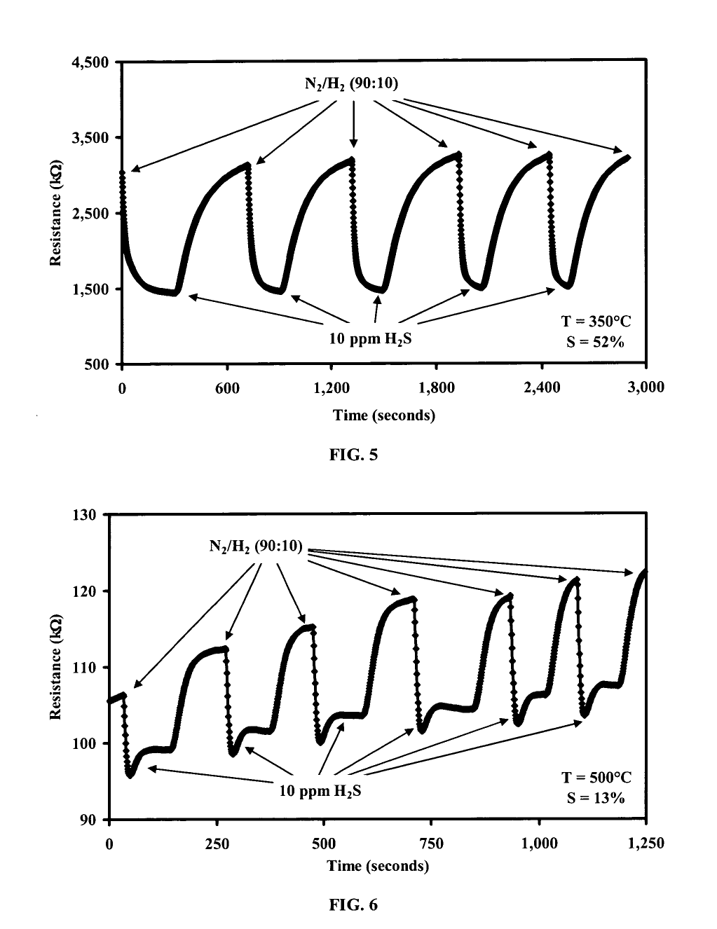

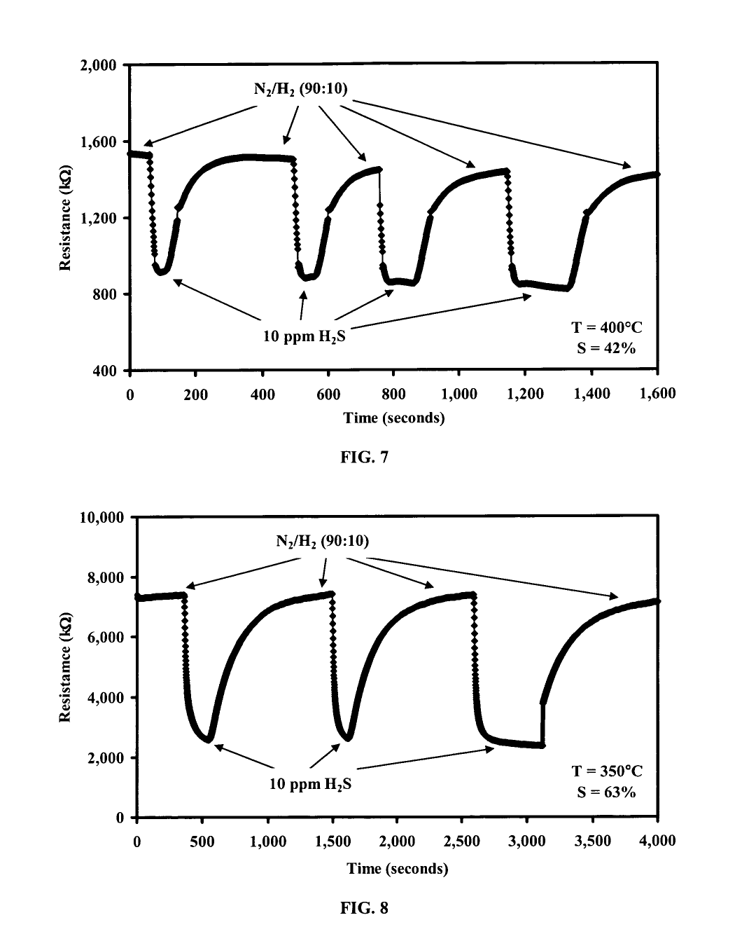

In the examples below, planar chemi-resistor films were deposited onto alumina substrates with inter-digitated gold electrodes printed on them, as shown in FIG. 1. The precursor powder consisted of nanoscale GDC (Ce_{0.90}Gd_{0.10}O₂₋ₓ) powder in which a second phase of molybdenum oxide (MoO₃) was homogeneously dispersed. Testing of the films was carried out in the temperature range of 295 to 500° C. A N₂/H₂ mixture in the volume ratio of 90:10 was used as the background gas and the film resistance of this stream was treated as the baseline. The sensor response was measured as the film resistance changed upon exposure to 10 ppm H₂S. The apparent response times are impacted by the large “dead volume” in the sensor testing apparatus. The sensor was cycled several times in the above temperature range during continuous testing over a period of 4 days. FIGS. 2 through 8 show the response of a 5 wt % MoO₃-95 wt % GDC sensor to 10 ppm H₂S in a N₂/H₂ background at various temperatures in the range of 295 to 500° C. These data are presented in the order they were collected. As shown in the test results, features of the sensor include:
1. The sensor formulation responds to H₂S in a gas stream containing 10 vol % H₂.
2. The sensor is reversible and the signal does not fade or dampen upon cycling during a given run or between several runs.
3. The sensitivity, defined as the percent change in resistance from the baseline resistance to the resistance in the presence of H₂S, is appreciable.
4. The response is linear with respect to temperature: higher at low temperatures and lower at high temperatures. This is consistent with many resistive-type sensors whose sensitivity declines with increase in temperatures due to the enhanced rate of desorption of the gaseous species of interest.
5. Upon aging, the response of the sensor at a given temperature appears to improve appreciably (e.g., FIGS. 2, 5 and 8).

The sensing behavior was not restricted to MoO₃-containing composites alone, nor was it was seen only in 5 wt % MoO₃-95 wt % GDC composites. Composites of GDC with a second phase selected from MoO₃, WO₃, TiO₂, and Sb₂O₃ in amounts ranging from 1 to 10 wt % have also shown response to 10 ppm of H₂S in N₂/H₂ mixtures. A typical response of a 5 wt % WO₃-95 wt % GDC sensor is shown in FIG. 9.

The sensors of the present invention were initially tested in hydrogen nitrogen backgrounds of low hydrogen content. Tests in environments with much higher hydrogen concentration suggest a change in the overall sensor mechanism. This is not surprising considering that the conductivity of GDC is strongly dependent on oxygen partial pressure. Even with four times the hydrogen concentration, the sensors are still sensitive in the presence of hydrogen; however, the resistance is seen to increase in the presence of hydrogen sulfide instead of decreasing. Without wishing to be bound by theory, this could result from a change of the underlying intrinsic conductivity of ceria that causes a change of the grain electron energy/mobility with respect to the grain boundary mobility/energy (more electrons as a result of low pO₂ will cause a change in the average electron energy within the grain), resulting in a modification of the Schottky barrier height to conduction.

The material compositions were deposited as thick films in a chemi-resistor₌format in inter-digitated electrodes for monitoring H₂S in H₂-rich gas stream that also contained carbon dioxide (CO₂). In this mode (chemi-resistor), the sensor film responds reversibly to the presence of H₂S via a change in the film resistance. The precursor powders consisted of nanoscale GDC powder in which second (and third) phases were homogeneously dispersed. The testing was carried out in the temperature range of 295 to 500° C. The sensor response was measured as the film resistance changed upon exposure to 1 to 10 ppm H₂S. The sensors were cycled several times in the above temperature range during continuous testing over a period of four days.

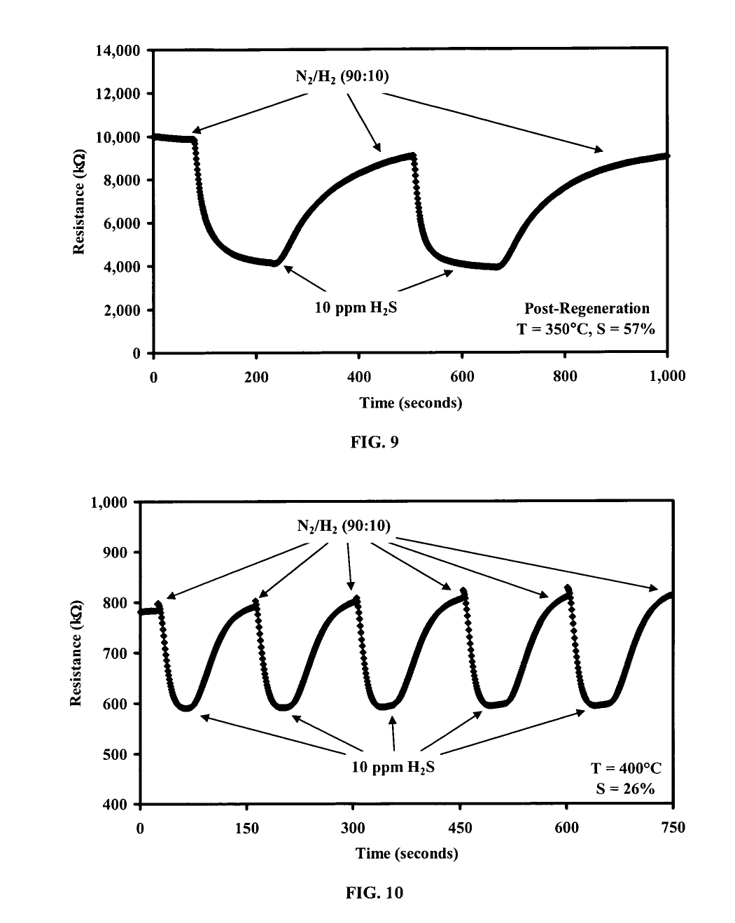

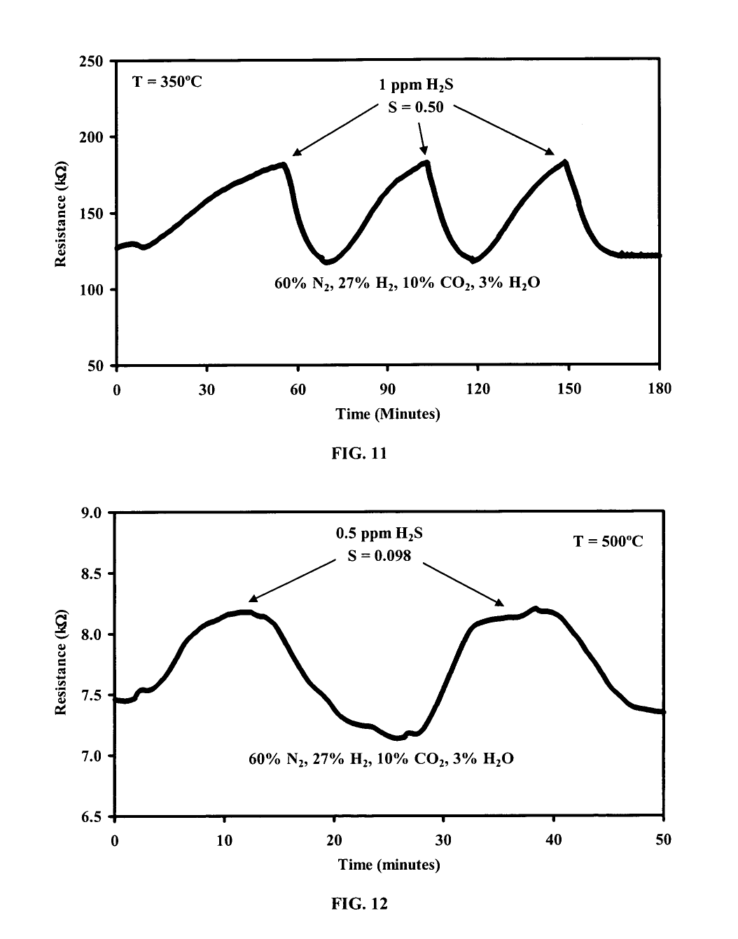

FIG. 10 shows the response of a representative 5 wt % MoO₃-10 wt % Al₂O₃-85% GDC sensor to 2.5 and 5 ppm H₂S at 500° C. in a humidified baseline gas comprised of 60% H₂, 27% H₂, 10% CO₂ and 3% H₂O. (Alumina was added as a third phase to increase the baseline resistance at the elevated temperature.) Other second phase additions were evaluated for H₂S sensitivity, including WO₃, TiO₂, and Sb₂O₃ but MoO₃ showed the best performance of the second phase additions evaluated. FIGS. 11 and 12 show the resistive responses of 5 wto/o MoO₃-10 wt % Al₂O₃-85 wt % GDC sensors to 1 and 0.5 ppm H₂S, respectively.

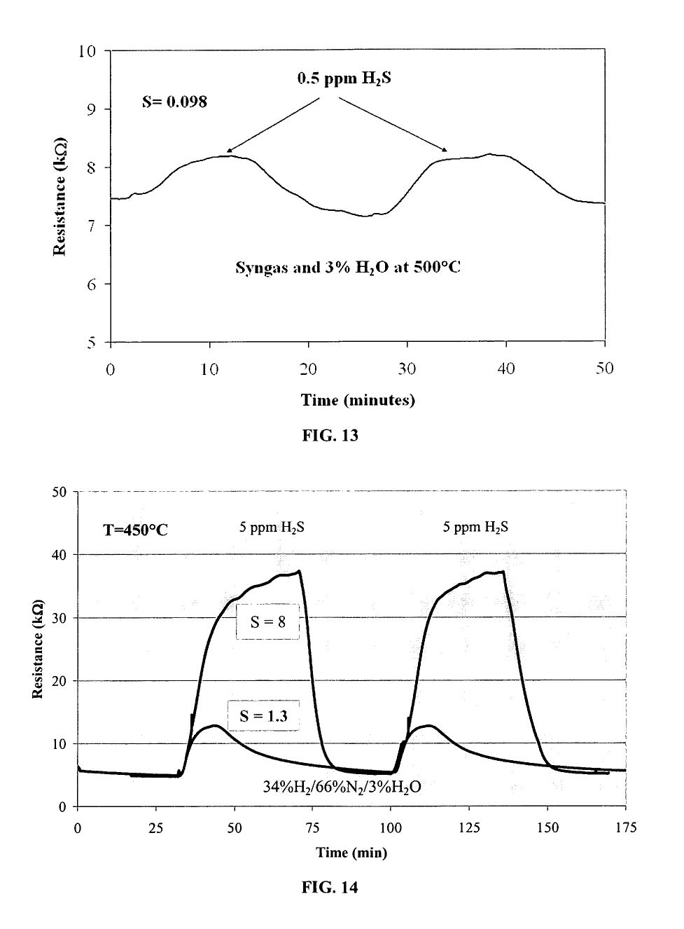

Pre-treatment of MoO₃-Al₂O₃-GDC sensor films to H₂S-containing hydrogen gas at elevated temperatures was found to have a dramatic positive impact on their H₂S sensitivity. This beneficial effect was observed by annealing sensors having a composition of 5 wt % MoO₃, 10 wt % Al₂O₃, and 85 wt % GDC at different temperatures (ranging from 450 to 600° C.) for 30 minutes in hydrogen with 5 ppm H₂S, and then measuring sensitivity of the sensors to 5 ppm H₂S at lower temperatures (ranging from 350 to 450° C.). The baseline gas for the sensitivity tests consisted of a gas mixture of 33% H₂ and 67% N₂ that was humidified to 3% H₂O. The sensitivity of the pretreated sensors to 5% H₂S at lower temperatures (ranging from 350 to 450° C.) was then measured The most pronounced improvement in sensitivity was observed for pretreatments at 600° C. FIG. 13 graphically shows the change in sensitivity for the for a 5 wt % MoO₃-15 wt % Al₂O₃-80 wt % GDC sensor tested at 450° C., before and after annealing at 600° C. in H₂ with 5 ppm H₂S. As shown in the figure, the annealing pre-treatment increased the H₂S sensitivity from 30 to 600 percent.

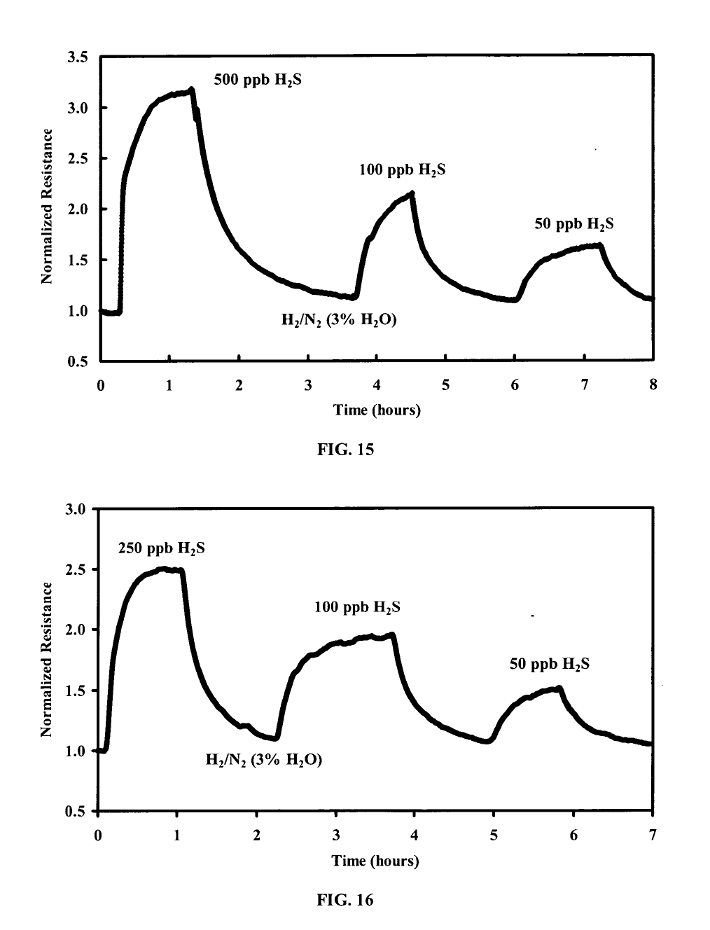

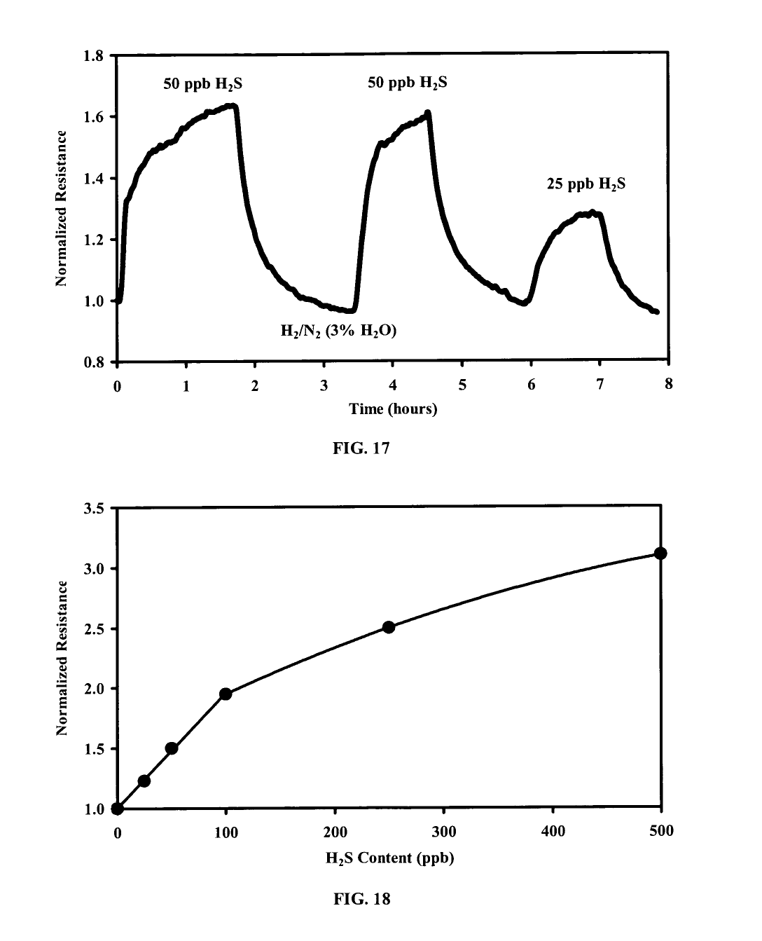

By using the high-temperature pretreatment step, the sensitivity of the GDC-MoO₃-Al₂O₃ sensors was increased so quantitative measurements of H₂S in hydrogen could be achieved, as shown in FIGS. 14 to 16. Sensitivity to H₂S content as low as 25 ppb was achieved with linear sensitivity within the 0 to 100 ppb H₂S range (see FIG. 17).

In many fuel cell systems that derive energy from hydrocarbon based fuels, it may be important to detect sulfur in gas streams other than hydrogen-rich streams. For example, it would be advantageous to detect H₂S in a methane-rich gas stream. The MoO₃-Al₂O₃-GDC sensors were found to be sensitive to 250 ppb H₂S in a dry baseline gas consisting of 98% CH₄ and 2% H₂, as shown in FIG. 18.

Tungstates and molybdates based on ABO₄ structures (where A=Ni, Cu, and ₌Zn) also may be useful as H₂S sensor compositions, either as single-phase sensor materials or as second phase additions to ceria-based materials (such as GDC, undoped CeO₂, Zr-doped ceria, and La-doped ceria). Experiments were conducted on NiWO₄ chemi-resistive sensors. To synthesize the powder of the NiWO₄ composition, 75.63 grams of WO₃ (Alfa-Aesar, 99.8%) and 24.37 grams of NiO (Novamet, Type A) were ball milled for 12 hours in 100 ml of isopropanol in a 500-ml Nalgene bottle and 200 grams of 3-mm round zirconia media. The material then was dried at 100° C. The dried powder was placed into a 100-ml high alumina crucible and calcined to 1000° C. for four hours. The powder was crushed and sieved through 60-mesh, then the powder was re-milled and dried.

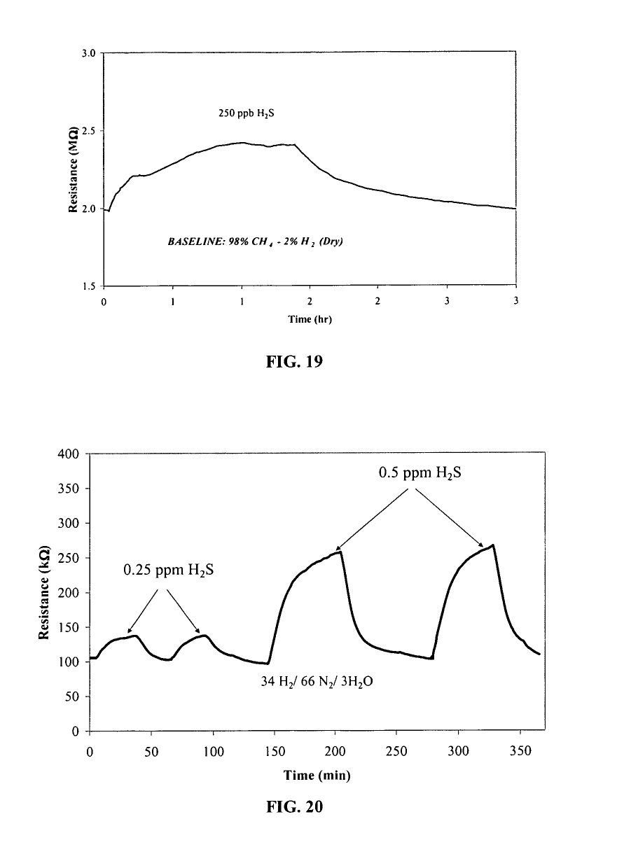

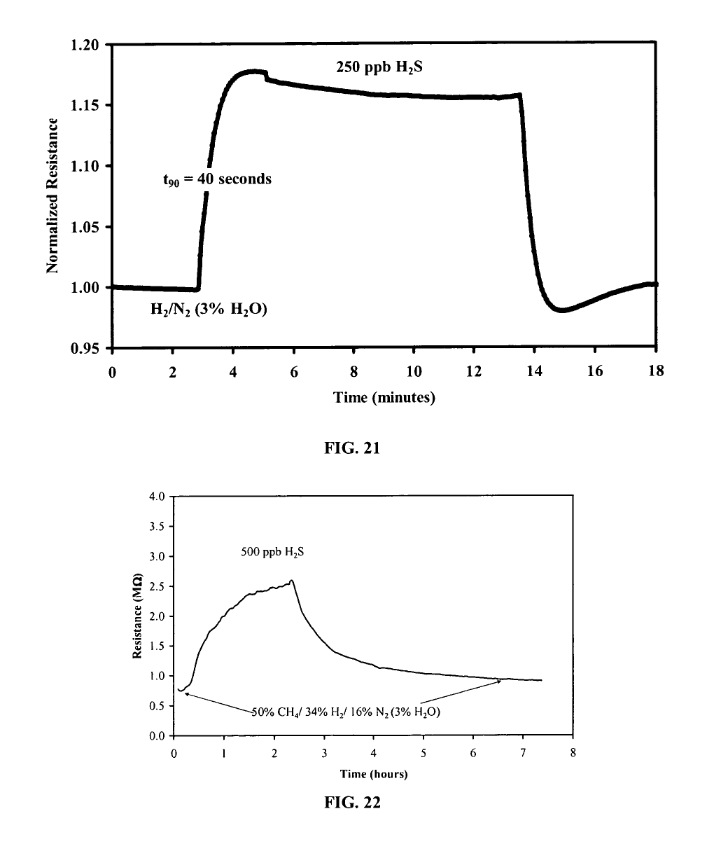

The NiWO₄ ink was prepared by combining 30 grams of powder with 8 grams of a terpineol-based ink vehicle. A handheld ultrasonic probe was used to disperse the powder into the ink vehicle. Additional powder was added slowly to the ink to thicken the ink to a viscosity of about 8000 cp. The ink was screen-printed onto an inter-digitated electrode and the sensor films were annealed at temperatures between 800 and 900° C. FIG. 19 shows the response of the NiWO₄ sensor to 250 and 500 ppb of H₂S in a humidified baseline gas consisting of 33% H₂ and 67% N₂. While the response time appears to be quite long, this is actually a result of the impractical sensor test volume used for the tests. A modified testing apparatus was used so that response time could be more accurately assessed. FIG. 20 shows the response time of the nickel tungstate sensor. The response time from the lower volume stand is less than one minute. Sensors made with NiWO₄ as the active coating also detected sulfur at the 500 ppb level in a humidified baseline gas consisting of 50% CH₄, 34% H₂ and 16% N₂ (see FIG. 21).

An onboard heater may be used to maintain the sensor at a selected temperature irrespective of the environment. Preferably, the heater is mounted on the backside of the alumina substrate with an alumina based bonding agent. The heater filament preferably is a NiCr coil but coils of platinum, ruthenium, or other suitable materials also may yield acceptable results. Other sensor device geometries may be used to exploit the chemi-resistive properties of the disclosed H₂S sensitive materials.

Throughout this specification, when a range of conditions or a group of substances is defined with respect to a particular characteristic (e.g., testing temperature, weight percents of constituents in composite sensor formulations, percentages of gaseous constituents used for testing, and the like) of the present invention, the present invention relates to and explicitly incorporates every specific member and combination of subranges or subgroups therein. Any specified range or group is to be understood as a short-hand way of referring to every member of a range or group individually as well as every possible subrange and subgroup encompassed therein; and similarly with respect to any subranges or subgroups therein.

Although specific embodiments of the invention have been described herein in detail, it stood that variations may be made thereto by those skilled in the art without departing spirit of the invention.

What is claimed is:

1. A sulfide-sensitive composition that responds reversibly to hydrogen sulfide in a reducing environment, the composition being selected from a binary metal oxide, a ternary metal oxide containing molybdenum, a ternary metal oxide containing tungsten, a quaternary metal oxide containing molybdenum, a quaternary metal oxide containing tungsten, and combinations thereof.

2. The sulfide-sensitive composition of claim 1, wherein the binary metal oxide is selected from ZnO, MoO₃, WO₃, NiO, CoO, and combinations thereof.

3. An H₂S sensor, comprising:
an electrode; and
the sulfide-sensitive composition of claim 1 applied to the electrode.

4. The H₂S sensor of claim 3, wherein the sulfide-sensitive composition is applied to the electrode as an ink.

5. A sulfide-sensitive composite material that responds reversibly to hydrogen sulfide in a reducing environment, the composite material comprising:
a metal oxide selected from a binary metal oxide, a ternary metal oxide containing molybdenum, a ternary metal oxide containing tungsten, a quaternary metal oxide containing molybdenum, a quaternary metal oxide containing tungsten, and combinations thereof; and
a ceria-based oxide composition.

6. An H₂S sensor, comprising:
a substrate;
an sulfide-sensitive composite material that responds reversibly to hydrogen sulfide in a reducing environment, the sulfide-sensitive material being deposited on the substrate such that the sulfide-sensitive material is connected to a pair of electrodes.

7. The H₂S sensor of claim 6, the sulfide-sensitive composite comprising:
a metal oxide selected from a binary metal oxide, a ternary metal oxide containing molybdenum, a ternary metal oxide containing tungsten, a quaternary metal oxide containing molybdenum, a quaternary metal oxide containing tungsten, and combinations thereof.

8. The H₂S sensor of claim 6, the sulfide-sensitive composite comprising:
at least one ceria-based oxide composition; and
a metal oxide selected from a binary metal oxide, a ternary metal oxide containing molybdenum, a ternary metal oxide containing tungsten, a quaternary metal oxide containing molybdenum, a quaternary metal oxide containing tungsten, and combinations thereof.

9. The H₂S sensor of claim 8, wherein the at least one ceria-based oxide composition is selected from undoped cerium oxide, doped cerium oxide, and combinations thereof.

10. The H₂S sensor of claim 6, further comprising:
alumina in an amount from 1 to 50 wt %.

11. The H₂S sensor of claim 10, further comprising:
a promoter selected from ruthenium, rhodium, palladium, platinum, gold, silver, and combinations thereof in an amount from 0.1 to 10 wt %.

12. An H₂S sensor, comprising:
a substrate;
an inter-digitated electrode deposited on the substrate; and
a sulfide-sensitive composite material deposited on the inter-digitated electrodes as a thick film in a chemi-resistor format, the sulfide-sensitive composite material comprising a composition selected from (1) 5 wt % MoO₃, 10 wt % alumina, and GDC, and (2) 5 wt % NiWoO₄, 10 wt % alumina, and GDC.

13. The H₂S sensor of claim 6 or claim 12, further comprising:
a promoter selected from ruthenium, rhodium, palladium, platinum, gold, silver, and combinations thereof in an amount from 0.1 to 10 wt %.

14. The H₂S sensor of claim 6 or claim 12, wherein the sensor is pretreated by exposure to a hydrogen gas stream that contains hydrogen sulfide gas at a temperature from 450-600° C.

15. The H₂S sensor of claim 14, wherein the pretreatment temperature is 600° C.

16. A method of making an H₂S sensor, the method comprising the steps of:
selecting a sulfide-sensitive composite material comprising:
a metal oxide selected from a binary metal oxide, a ternary metal oxide containing molybdenum, a ternary metal oxide containing tungsten, a quaternary metal oxide containing molybdenum, a quaternary metal oxide containing tungsten, and combinations thereof; and
a ceria-based oxide composition; and
depositing the sulfide-sensitive composite material on a substrate as a thick film in a chemi-resistor format; and
connecting a pair of electrode to the sulfide-sensitive composite material.

17. The method of claim 16, wherein the sulfide-sensitive composite further comprises alumina in an amount from 1 to 50 wt %.

18. The method of claim 16 or claim 17, wherein the sulfide-sensitive composite further comprises a promoter selected from ruthenium, rhodium, palladium, platinum, gold, silver, and combinations thereof in an amount from 0.1 to 10 wt %.

19. The method of claim 16, further comprising the step of:
pretreating the sensor by exposure to a hydrogen gas stream that contains hydrogen sulfide gas at a temperature from 450-600° C.
